(19) United States
(12) Patent Application Publication
(10) Pub. No.: US 2020/0092248 A1
(43) Pub. Date: Mar. 19, 2020

(54) Mobile Application with Dating Questionnaire

(71) Applicants: Ann Brennan, Okemos, MI (US); Jennifer Brennan, Okemos, MI (US)

(72) Inventors: Ann Brennan, Okemos, MI (US); Jennifer Brennan, Okemos, MI (US)

(21) Appl. No.: 16/131,571

(22) Filed: Sep. 14, 2018

(51) Int. Cl. H04L 12/58; G06F 3/0481; G06K 19/06; G06Q 30/02; G06Q 50/00

(52) U.S. Cl. CPC H04L 51/32; G06F 3/0481; G06Q 50/01; G06Q 30/0203; G06K 19/06037

(57) ABSTRACT

A method having the following steps: (1) receiving input from a first user to open a mobile application of a dating questionnaire with a first electronic device and solicit first user data about a possible interaction; (2) prompting the first user to access a first user avatar; (3) prompting responses from first user to questions from the dating questionnaire; (4) displaying the first user avatar in which the first user avatar visually gestures a confirmation that the responses were successfully received; (5) transmitting an invitation to a second electronic device associated with the second user; (6) providing a digital prompt that enables the second user to access the mobile application; (7) prompting the second user to access a second user avatar; (8) displaying the first user avatar and the second user avatar in a virtual meeting; (9) providing the first user data to the second user; (10) prompting the second user to enter their responses to the dating questionnaire; (11) comparing the first user data (responses) and the second user data (responses); and (12) identifying differences, if any, between the first user data and the second user data.

### FIELD OF THE INVENTION

The present invention generally relates to a mobile application that includes a dating questionnaire, and more specifically a questionnaire designed to verify a consensual agreement between the parties to proceed with an interaction.

### BACKGROUND

From time immemorial, most people have typically wanted to find that special person to share their life with. In most situations, that process happens by meeting someone for one or more dates and sometimes issues may arise where one party wants to increase the level of intimacy or interaction between the parties. While transparency and good communication may solve said issues, there may be some amount of confusion or less than a full understanding about the intentions of one or both parties.

The question about if and when to increase the intimacy or interaction level is not exclusive to women or men, even though each may view the other's intentions in a different way. Good communication beforehand may go a long way to ensure there are no mixed signals or unclear expectations.

### BRIEF SUMMARY OF THE INVENTION

One embodiment of the present invention is generally directed toward at least one non-transitory computer readable medium storing instructions that, when executed by at least one processor, causes the at least one processor to perform a method having the following steps: (1) receiving an input from a first user to open a mobile application accessible by a first electronic device, the mobile application including a dating questionnaire configured to solicit first user data from the first user and solicit second user data from a second user, wherein the first user desires to have an interaction with the second user; (2) prompting the first user to access a pre-designed first user avatar or generate a new first user avatar; (3) prompting the first user to enter the first user data in response to one or more questions generated by the dating questionnaire; (4) graphically displaying the first user avatar on a display screen of the first electronic device, the graphical display comprising the first user avatar visually gesturing a confirmation that the responses to the dating questionnaire associated with the first user data were successfully received; (5) transmitting an invitation to a second electronic device associated with the second user; (6) if the second electronic device does not have access to the mobile application, the invitation to the second electronic device provides a digital prompt that enables the second user to access the mobile application; (7) prompting the second user to access a pre-designed second user avatar or generate a new second user avatar; (8) graphically displaying the first user avatar and the second user avatar coming together in a virtual meeting; (9) providing the first user data to the second user; (10) prompting the second user to enter the second user data in response to the one or more questions generated by the dating questionnaire; (11) comparing the first user data and the second user data; and (12) identifying differences, if any, between the first user data and the second user data.

Another embodiment of the present invention is directed toward a system having a server with a hardware processor and memory coupled to the processor. The server is accessible to communicate with the first electronic device and the second electronic device, wherein the server is configured to receive first user data from the first electronic device, wherein the server is configured to receive second user data from the second electronic device, and wherein the first user data and the second user data comprise responses to questions supplied by a dating questionnaire accessible through an application on first and second electronic devices. The system prompts the first user to access a pre-designed first user avatar or generate a new first user avatar and then prompts first user to enter the first user data in response to one or more questions generated by the dating questionnaire. The system graphically displays the first user avatar on a display screen of the first electronic device, the graphical display includes the first user avatar visually gesturing a confirmation that the responses to the dating questionnaire associated with the first user data were successfully received. The system then transmits an invitation to a second electronic device associated with the second user. If the second electronic device does not have access to the mobile application, the invitation to the second electronic device provides a digital prompt that enables the second user to access the mobile application. The system then prompts the second user to access a pre-designed second user avatar or generate a new second user avatar. The system graphically displays the first user avatar and the second user avatar coming together in a virtual meeting. The system then provides the first user data to the second user. Next, the system prompts the second user to enter the second user data in response to the one or more questions generated by the dating questionnaire and then compares the first user data and the second user data. Lastly the system is configured to identify differences, if any, between the first user data and the second user data.

### BRIEF DESCRIPTION OF THE DRAWINGS

Non-limiting and non-exhaustive embodiments of the present invention are described with reference to the following drawings. In the drawings, like reference numerals refer to like parts or like steps throughout the various figures unless otherwise specified:

FIG. 1 is a flow diagram for a method for accessing and sharing a dating questionnaire according to an embodiment of the present invention;

FIG. 2 is a plan view of an electronic device hosting a mobile application for accessing and sharing a dating questionnaire according to an embodiment of the present invention;

FIG. 3 is a plan view of the electronic device of FIG. 1 showing the dating questionnaire according to an embodiment of the present invention;

FIG. 4 is a plan view of the electronic device of FIG. 1 showing a menu for customizing an avatar according to an embodiment of the present invention; and

FIG. 5 is a flow diagram for a method for accessing and sharing a dating questionnaire according to another embodiment of the present invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with mobile applications, dating questionnaires, and the methods of configuring and/or using the same have not necessarily been shown or described in detail to avoid unnecessarily obscuring descriptions of the embodiments of the invention. For purposes of the present description, the terms person, user, party and the plurals thereof to indicate an interaction scenario, but it is understood that the present invention is not limited by these terms and other terms, such as an “individual” may also apply. Further, the term “first user” generally indicates the person who initiates or communicates an interest in having an interaction with the “second user;” however these terms may be interchangeable.

The present invention is generally directed to a mobile application that includes a dating questionnaire, and more specifically a questionnaire designed to verify a consensual agreement between the parties to proceed with an interaction.

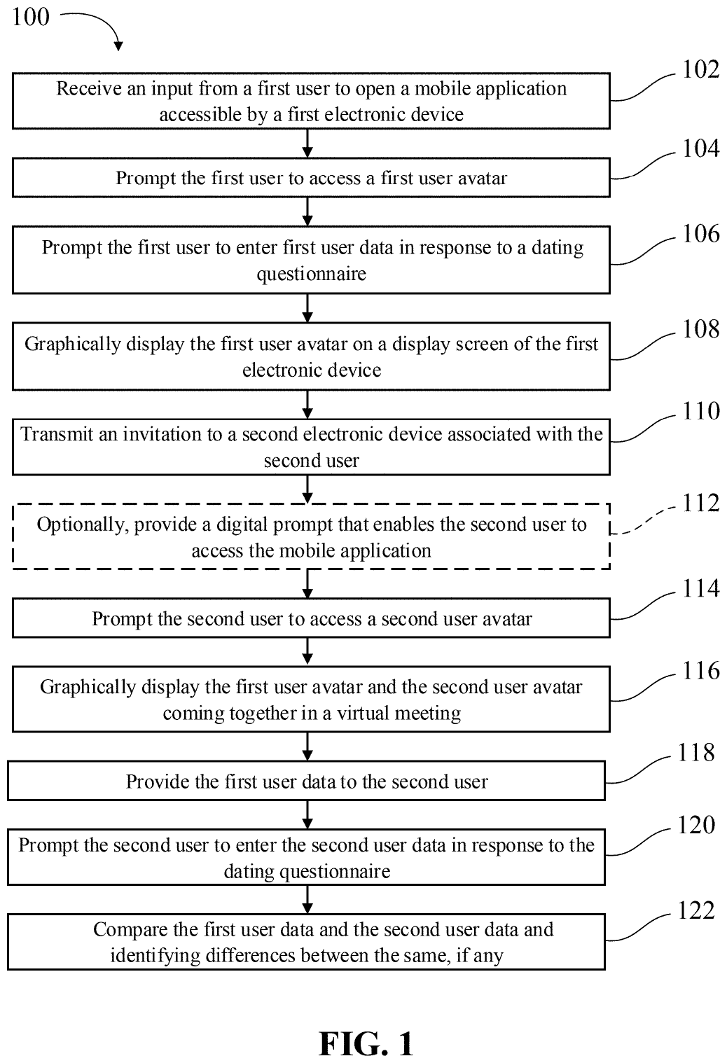

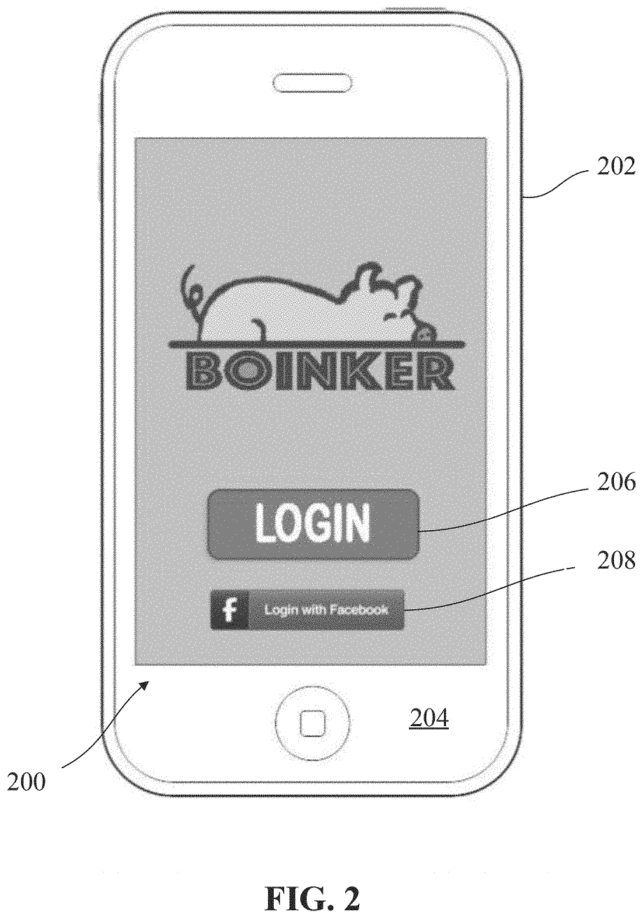

FIG. 1 shows a method 100 that causes a processor to enable a dating questionnaire that may be accessed by one person and shared with another person. FIGS. 2-4 show various aspects of the present invention and should be referred to along with FIG. 1 in the following description. In one embodiment of the present invention, Step 102 shows that a first user accesses and provides input to a mobile application 200 that is accessible by a first electronic device 202 such as, but not limited to a smartphone, a digital tablet, a laptop or some other type of electronic device that has a display screen 204 and an input mechanism. The first user may login 206 (e.g., sign into) to the mobile application 200 using their social media account 208 (e.g., Facebook®) or another type of login or sign in method. After logging into the mobile application 200, a dashboard may be displayed on the display screen 204 of the first electronic device 202. Upon receiving the input from the first user, the mobile application 200 accesses a dating questionnaire configured to solicit first user data from the first user and solicit second user data from a second user. One purpose of the dating questionnaire may be to allow for clear and unambiguous communication that the first user desires to have an interaction with the second user.

In one embodiment of the present invention, the dating questionnaire may solicit responses to a number of questions such as, but not limited to: (1) is the responding party over the age of eighteen (18)?; Can the responding party provide proof of their age?; (3) is the responding party have any sexual transmitted disease or has the responding party recently been subjected to a sexual transmitted disease?; (4) would the responding party prefer prophylactic measure for birth control or safe sex?; (5) is the responding party of sound and competent mind (i.e., not drunk, high, buzzed, or any other condition that may raise a concern about the responding party's ability to provide consent?; (6) would the responding party need a ride home after the interaction?; and (7) would the responding party prefer to have the address of where the interaction will occur?

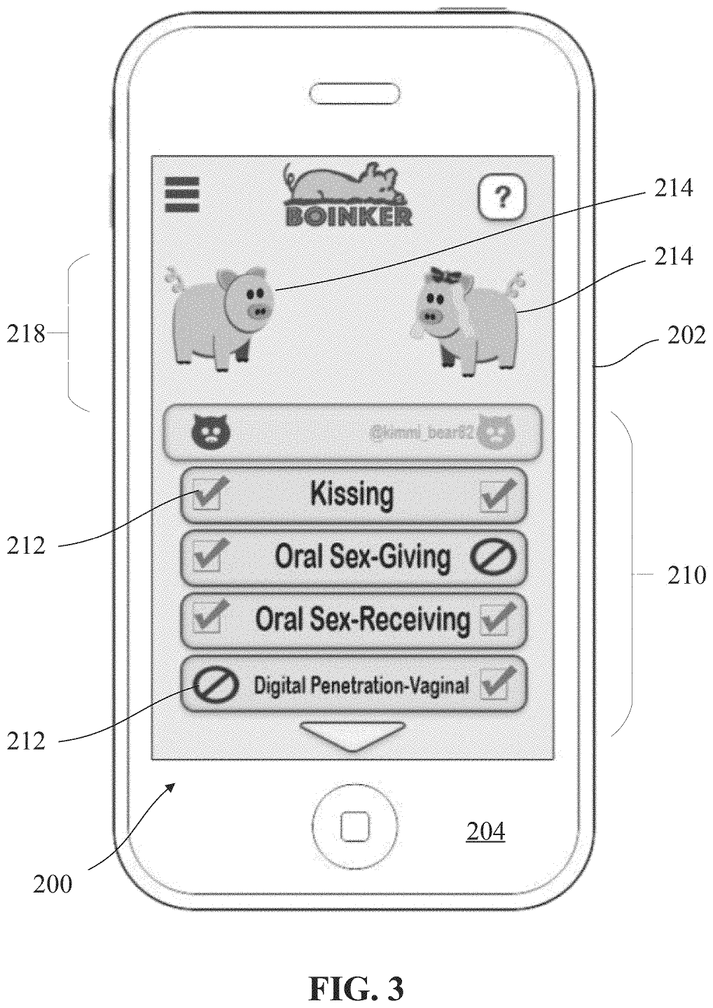

Additionally or alternatively and by way of example as shown in FIG. 3, the questionnaire 210 may solicit more specific questions that may be directed to specific activities that may be engaged upon during the interaction between the parties. In the illustrated example, the parties may provide answers 212 in the affirmative or in the negative as to whether the party desires to engage in a specific activity.

In one embodiment, the mobile application 200 may store or archive the answers 212 of the responding party for a future occasion and save the settings for the customized avatar 214. In the present embodiment, the completion of the customized avatar 214 may be shown celebrating in some manner on the display screen 204.

At Step 104, the mobile application 200 prompts the first user to access a pre-designed first user avatar or generate a new first user avatar. At Step 106, the mobile application 200 prompts the first user to enter the first user data in response to one or more questions generated by the dating questionnaire 210. At Step 108, the first electronic device 202 graphically displays the first user avatar on the display screen 204 of the first electronic device 202. In the present embodiment, the avatar 214 may take the form of a cartoon character such as, but not limited to a cartoon-style pig. In one embodiment, the mobile application 200 may prompt the first user to customize the first user avatar. The graphical display may show the first user avatar visually gesturing a confirmation that the responses to the dating questionnaire associated with the first user data were successfully received.

At Step 110, the first user may provide an input to the first electronic device, where such input causes the first electronic device to transmit an invitation to a second electronic device associated with the second user. Optionally at Step 112, the first electronic device may provide a digital prompt such as, but not limited to a quick response (QR) code or a uniform resource locator (URL) link, that enables the second user to access the mobile application.

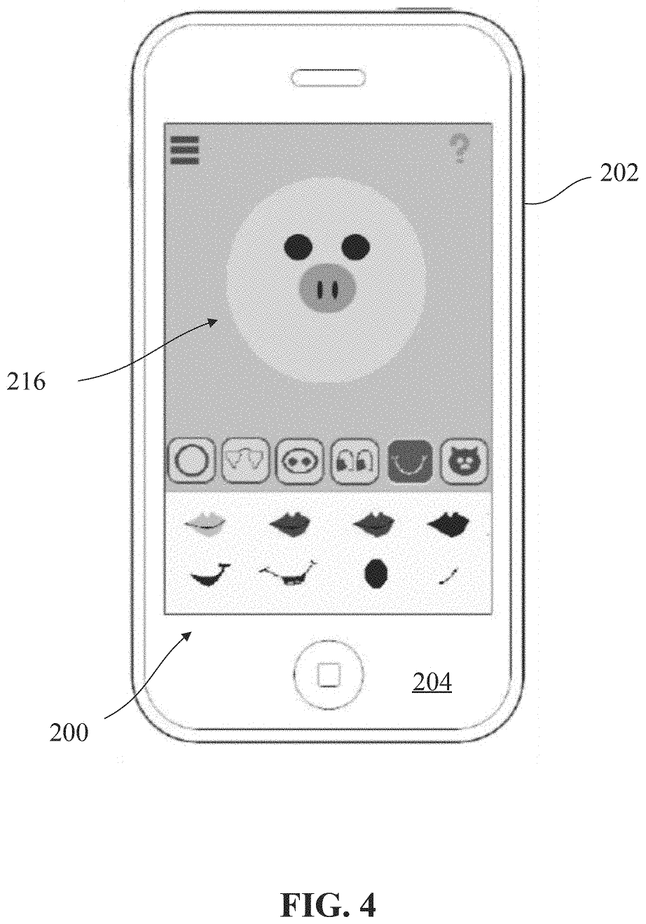

Upon accepting the invitation or accessing the URL link, the mobile application 200 is displayed on and accessible on the second electronic device. At Step 114, the mobile application 200 may then prompt the second user to access a pre-designed second user avatar or create a new second user avatar 216 (FIG. 4). Like the first user, the second user may be provided an option to customize the second user avatar 216. In the present embodiment, the second user may customize a cartoon-style pig.

At Step 116, the mobile application 200 may graphically display the first user avatar and the second user avatar coming together in a virtual meeting 218 (FIG. 2). At Step 118, the mobile application 200 transmits the first user data to the second user by way of the respective electronic devices.

At Step 120, the mobile application 200 may prompt the second user to enter second user data in response to one or more questions generated by the dating questionnaire. At Step 122, the mobile application 200 compares the first user data to the second user data. And at Step 124, the mobile application 200 identifies differences between the first user data and the second user data and displays those differences, if any, to both the first and the second users. Optionally, both the first user data and the second user data may be archived on the users' respective electronic devices.

In another embodiment, the mobile application 200 may prompt the first user, the second user, or both to provide additional input to one or more supplemental questions generated by the mobile application. Such a prompt may be initiated by one of the users or may result from the differences identified during Step 122. In another embodiment, the mobile application 200 may display at least one disclaimer about the dating questionnaire to both the first and second users. In yet another embodiment, the mobile application 200 may prompt at least the second user to confirm or deny whether the second user understands that the first user desires to have an interaction with the second user. In yet another embodiment, the mobile application 200 may provide a prompt to the first user, the second user, or both to provide a location to a third party about where the interaction will occur. And in yet another embodiment, the mobile application 200 may provide a prompt to the first user, the second user, or both to forward the first user data and the second user data to an alternate platform such as, but not limited to, a cloud server, another application, a digital notebook, an email account or any other platform where the data would be secure, especially if one of the users misplaced their electronic device.

The transmission of the first user data to the second user and the transmission of the second user data to the first user may be accomplished using a QR code. Additionally or alternatively, the transmission of the first user data to the second user and the transmission of the second user data to the first user may be accomplished using a URL link.

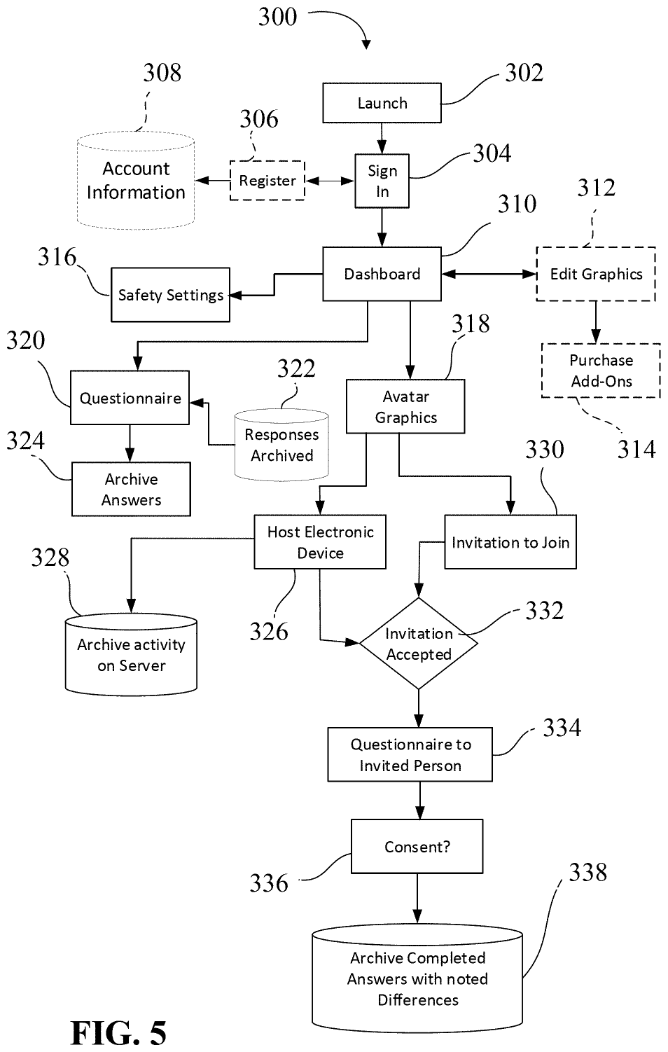

FIG. 5 shows another method 300 that causes a processor to enable a dating questionnaire that may be accessed by one person and shared with another person. At Step 302, a first person launches a mobile application to access the dating questionnaire. At Step 304, the first person logs in or signs in to the mobile application, which may be accomplished by using another platform such as, but not limited to, a social media platform, an email platform or some other platform. Optionally at Step 306, if the first person has not registered for the mobile application, the first person may register for the mobile application via email, social media or some other platform. Optionally at Step 308, the first person may input additional information into the first person's account or the mobile application may prompt the first user to input additional information.

At Step 310, the mobile application displays a dashboard that serves as a multipage, swipe interface for navigating the various pages or screens of the mobile application according to an embodiment of the present invention. Optionally at Step 312, the first person may be prompted to edit at least some of the graphic content of the mobile application. By way of example, the first person may adjust or customize the design of an avatar. In one embodiment, the customization options may include facial and accessory aspects for the avatar and may be changed at a later time. Once the avatar has been customized, the first person may save the changes and upload the avatar settings to a server. Additionally and optionally at Step 314, the mobile application may prompt the first user to purchase add-on modules for the mobile application. By way of example, the add-on modules may provide additional options for avatar customization, additional questions for the questionnaire, and other upgrades for the mobile application. At Step 316, the mobile application may provide a link for the first user to access one or more safety settings on the mobile application. By way of example, the safety settings may be a current physical location of the first person, a future physical location of the first person, emergency contact information, email settings, etc.

At Step 318, the dashboard displays an avatar, which may be a generic avatar or a customized avatar. At Step 320, the dashboard displays the questionnaire that includes a yet-to-be answered question or questions. Additionally or alternatively at Step 322, the questionnaire may. In one embodiment, the mobile application may prompt the first person to answer new questions, edit responses to previously-answered questions, or add more detail to previously-answered questions. In one embodiment, the questions may focus on activities that the first person may desire and/or consent to. At Step 324, the mobile application may prompt the first user to save or archive the answers to the questionnaire, which may be saved on the server.

At Step 326, the mobile application prompts the first user to host a second person having a second electronic device. The process of hosting creates a record within an activity database 328 associated with the first person's electronic device. At Step 330, the first person may send an invitation to the second person to join the mobile application. Joining the mobile application may require the second person to download the mobile application on the second electronic device. At any time, the first person may cancel the invitation. At Step 332, the second person may accept the invitation from the first person.

At Step 334, the mobile application prompts the second person to input responses to the questionnaire, which is the same questionnaire to which the first person responded to at Step 320. At Step 336, the mobile application prompts the first and second persons to confirm or reject consent to the activities suggested in the questionnaire. At Step 338, the mobile application saves or archives the responses or answers to the questionnaire and identifies any differences in the responses from the respective parties. In one embodiment, the mobile application saves or archives all responses from both parties to the server as well as the consent response from Step 336. Additionally, the mobile application may transmit the responses to the questionnaire and the consent response to a platform such as, but not limited to, an email platform.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. At least one non-transitory computer readable medium storing instructions that, when executed by at least one processor, causes the at least one processor to perform a method comprising:
receiving an input from a first user to open a mobile application accessible by a first electronic device, the mobile application including a dating questionnaire configured to solicit first user data from the first user and solicit second user data from a second user, wherein the first user desires to have an interaction with the second user;
prompting the first user to access a pre-designed first user avatar or generate a new first user avatar;
prompting the first user to enter the first user data in response to one or more questions generated by the dating questionnaire;
graphically displaying the first user avatar on a display screen of the first electronic device, the graphical display comprising the first user avatar visually gesturing a confirmation that the responses to the dating questionnaire associated with the first user data were successfully received;
transmitting an invitation to a second electronic device associated with the second user;
if the second electronic device does not have access to the mobile application, the invitation to the second electronic device provides a digital prompt that enables the second user to access the mobile application;
prompting the second user to access a pre-designed second user avatar or generate a new second user avatar;
graphically displaying the first user avatar and the second user avatar coming together in a virtual meeting;
providing the first user data to the second user;
prompting the second user to enter the second user data in response to the one or more questions generated by the dating questionnaire;
comparing the first user data and the second user data; and
identifying differences, if any, between the first user data and the second user data.

2. The method of claim 1, further comprising archiving the first user data.

3. The method of claim 1, further comprising archiving the second user data.

4. The method of claim 1, further comprising soliciting at least one of the first user or the second user to input additional questions to supplement the dating questionnaire.

5. The method of claim 1, further comprising displaying to the first and second users at least one disclaimer about the dating questionnaire.

6. The method of claim 1, further comprising prompting at least the second user to confirm or deny whether the second user understands that the first user desires to have the interaction with the second user.

7. The method of claim 1, further comprising prompting the first user, the second user, or both to provide a location to a third party about where the interaction will occur.

8. The method of claim 1, further comprising prompting the first user, the second user, or both to forward the first user data and the second user data to a different platform.

9. The method of claim 8, wherein the different platform comprises an email account.

10. The method of claim 1, wherein transmitting the digital prompt includes transmitting a quick response (QR) code.

11. The method of claim 1, wherein transmitting the digital prompt includes transmitting a uniform resource locator (URL) link.

12. A system comprising:
a server having a hardware processor and memory coupled to the processor, wherein the server is accessible to communicate with a first electronic device and a second electronic device, wherein the server is configured to receive first user data from the first electronic device, wherein the server is configured to receive second user data from the second electronic device, and wherein the first user data and the second user data comprise responses to questions supplied by a dating questionnaire accessible through an application on the first and second electronic devices;
prompt the first user to access a pre-designed first user avatar or generate a new first user avatar;
prompt the first user to enter the first user data in response to one or more questions generated by the dating questionnaire;
graphically display the first user avatar on a display screen of the first electronic device, the graphical display comprising the first user avatar visually gesturing a confirmation that the responses to the dating questionnaire associated with the first user data were successfully received;
transmit an invitation to a second electronic device associated with the second user;
if the second electronic device does not have access to the mobile application, the invitation to the second electronic device provides a digital prompt that enables the second user to access the mobile application;
prompt the second user to access a pre-designed second user avatar or generate a new second user avatar;
graphically display the first user avatar and the second user avatar coming together in a virtual meeting;
provide the first user data to the second user;
prompt the second user to enter the second user data in response to the one or more questions generated by the dating questionnaire;
compare the first user data and the second user data; and
identify differences, if any, between the first user data and the second user data.

13. The system of claim 12, further comprising accessing the server to archive the first user data.

14. The system of claim 12, further comprising accessing the server to archive the second user data.

15. The system of claim 12, further comprising solicit at least one of the first user or the second user to input additional questions to supplement the dating questionnaire.

16. The system of claim 12, further comprising display to the first and second users at least one disclaimer about the dating questionnaire.

17. The system of claim 12, further comprising prompt at least the second user to confirm or deny whether the second user understands that the first user desires to have the interaction with the second user.

18. The system of claim 12, further comprising prompt the first user, the second user, or both to provide a location to a third party about where the interaction will occur.

19. The system of claim 12, further comprising prompt the first user, the second user, or both to forward the first user data and the second user data to a different platform.

20. The system of claim 12, wherein the digital prompt includes transmitting at least one of a quick response (QR) code or a uniform resource locator (URL) link.
